(19) United States
(12) Patent Application Publication
(10) Pub. No.: US 2009/0016013 A1
(43) Pub. Date: Jan. 15, 2009

(54) ELECTRONIC APPARATUS HAVING IMPROVED VIBRATION ABSORPTION

(75) Inventors: Toshikatsu Nakamura, Akishima-shi (JP); Jyoji Kusamoto, Urayasu-shi (JP); Yuichi Hirai, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/061,402

(22) Filed: Apr. 2, 2008

(30) Foreign Application Priority Data
Jul. 13, 2007 (JP) 2007184914

(51) Int. Cl. G06F 1/16

(52) U.S. Cl. 361/685

(57) ABSTRACT

An electronic apparatus includes: a case that is provided with a mounting slot; and a disk device that is mounted in the mounting slot, the disk device including: a main body that is formed in a box shape; a resin sheet that is wrapped around the main body; and a plurality of cushion members that are disposed between the main body, wherein the cushion members are arranged on the resin sheet at positions where correspond to corners of the main body in a state where the resin sheet is wrapped around the main body.

### CROSS-REFERENCE TO RELATED APPLICATIONS

This application is based upon and claims the benefit of priority from Japanese Patent Application No. 2007-184914, filed on Jul. 13, 2007, the entire content of which are incorporated herein by reference.

### BACKGROUND

1. Field

One embodiment of the invention relates to an electronic apparatus having a disk device that is improved in vibration absorption performance.

2. Description of the Related Art

Conventionally, there is proposed to improve impact resistance of a disk device, such as a hard disk drive (HDD), in the following configuration. The disk device having such configuration is equipped with a flat-box shaped main body, a resin sheet having creases and opposed to an outer circumferential faces of the main body, impact absorption sheets made of a foamed material, and an outer casing that houses those components. The resin sheet has two or more confronting faces to be opposed to the associated outer circumferential faces of the main body, and the impact absorption sheets are bonded to the entire confronting faces, respectively.

In thus configured conventional disk device, the impact absorption sheets, which serves as an impact absorption member, are formed by bonding the foamed sheets to the general-purpose resin sheet. Therefore, the disk device is low in manufacturing cost because it is not necessary to prepare an integrally formed, dedicated impact absorption member. An example of such disk device is disclosed in JP-A-2001-148186.

The disk device is installed in a case of a portable computer and used for reading and writing data.

In recent years, many portable computers are introduced into the market with a configuration having sound output function being enhanced by improving a performance of built-in speakers. Such portable computers are preferred to be equipped with a disk device that is not only high in impact resistance (mentioned above) but also resistant to vibrations generated by the built-in speakers. However, the impact absorption member of the above-described conventional disk device is not designed to absorb vibrations generated by the built-in speakers.

### SUMMARY

One of objects of the present invention is to provide an electronic apparatus having a disk device capable of minimizing influence of vibration and increasing the workability when the disk device is attached to the electronic apparatus.

According to a first aspect of the present invention, there is provided an electronic apparatus including: a case that is provided with a mounting slot; and a disk device that is mounted in the mounting slot, the disk device including: a main body that is formed in a box shape; a resin sheet that is wrapped around the main body; and a plurality of cushion members that are disposed between the main body, wherein the cushion members are arranged on the resin sheet at positions where correspond to corners of the main body in a state where the resin sheet is wrapped around the main body.

According to a second aspect of the present invention, there is provided a disk device that is configured to be mounted in a mounting slot provided in a case of an electronic apparatus, the disk device including: a main body that is formed in a box shape; a resin sheet that is wrapped around the main body; and a plurality of cushion members that are disposed between the main body, wherein the cushion members are arranged on the resin sheet at positions where correspond to corners of the main body in a state where the resin sheet is wrapped around the main body.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a portable computer according to an embodiment of the present invention.

FIG. 2 is a perspective view, as viewed from below, of the portable computer shown in FIG. 1.

FIG. 3 is a perspective view of a disk device which is inserted in a mounting slot (shown in FIG. 2) of the portable computer of FIG. 1.

FIG. 3 is a bottom view of the disk device of FIG. 3.

FIG. 5 is a development view of a resin sheet of the disk device of FIG. 3.

FIG. 6 is an exploded perspective view of the disk device of FIG. 3 showing its assembling process.

FIG. 7 is a perspective view showing a step of inserting the disk device of FIG. 6 into the mounting slot.

### DETAILED DESCRIPTION

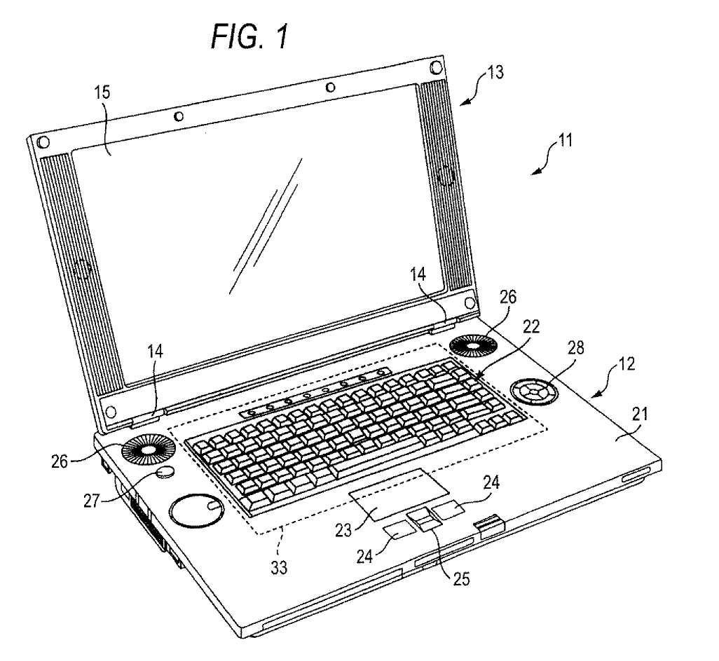

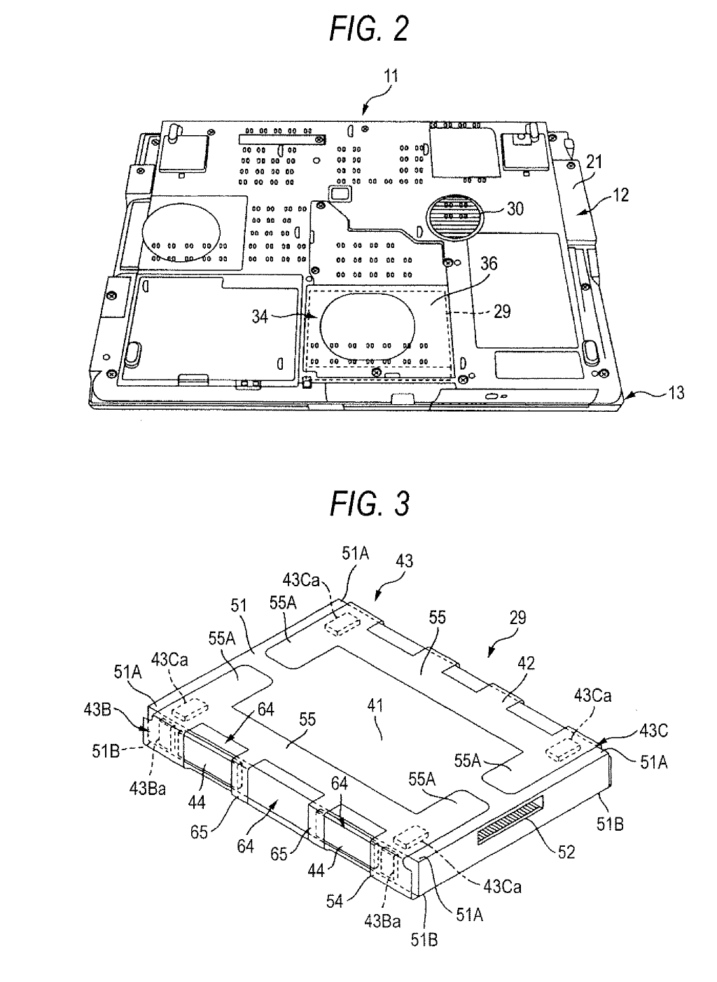

An embodiment of the present invention will be hereinafter described with reference to FIGS. 1-7. As shown in FIG. 1, a portable computer 11, which will be described as an exemplary embodiment of an electronic apparatus according to the present invention, is configured as a so-called a laptop PC. The portable computer 11 is equipped with a main body unit 12, a display unit 13, and hinge portions 14 that are disposed between the main body unit 12 and the display unit 13. The hinge portions 14 support the display unit 13, whereby the display unit 13 can rotate with respect to the main body unit 12. The display unit 13 has a display device 15. As shown in FIGS. 1 and 2, the main body unit 12 is equipped with a resin case 21, a keyboard 22, a touch pad 23, as a pointing device, and buttons 24, a finger print sensor 25, main speakers 26, a power switch 27, a manipulation member 28 for manipulating musical functions, and a disk device 29. A printed circuit board 33 mounted with electronic components such as a CPU (central processing unit) is provided inside the case 21 of the main body unit 12. As shown in FIG. 2, the main body unit 12 is equipped with a subwoofer 30 which is a lower-register speaker at a position that is adjacent to the bottom face of the case 21.

The case 21 has a substantially box shape. As shown in FIG. 2, the case 21 has a mounting slot 34 to be mounted with the disk device 29. As shown in FIG. 7, the mounting slot 34 is formed by a recess that is recessed from the surrounding portion of the case 21. As shown in FIG. 7, the case 21 has conductive ground layers 35 on the inner circumferential faces and the bottom face of the mounting slot 34. For example, the ground layers 35 are formed by coating those faces of the mounting slot 34 with a copper-nickel material. The ground layers 35 are electrically connected to ground layers that are separately provided on the inner faces of the case 21. As shown in FIG. 2, the case 21 also has a lid member 36 for covering the recess.

The disk device 29 is a hard disk drive (HOD), for example. However, the disk device 29 is not limited to a hard disk drive and may be any disk devices, such a floppy disk drive, an optical disc drive, and a magneto-optical disc drive.

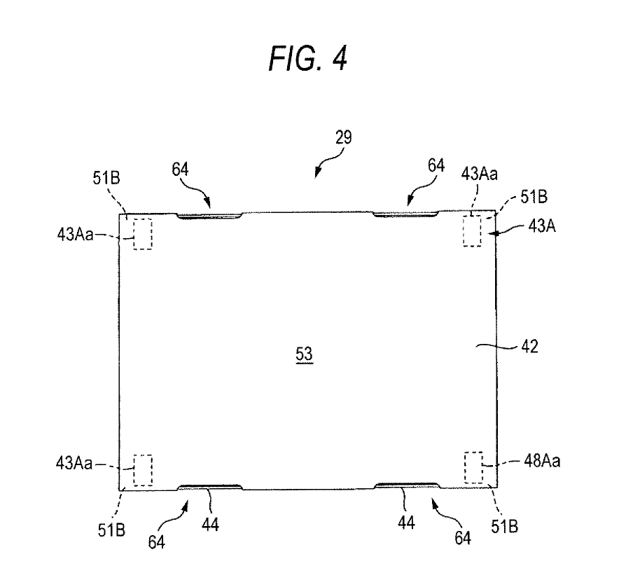

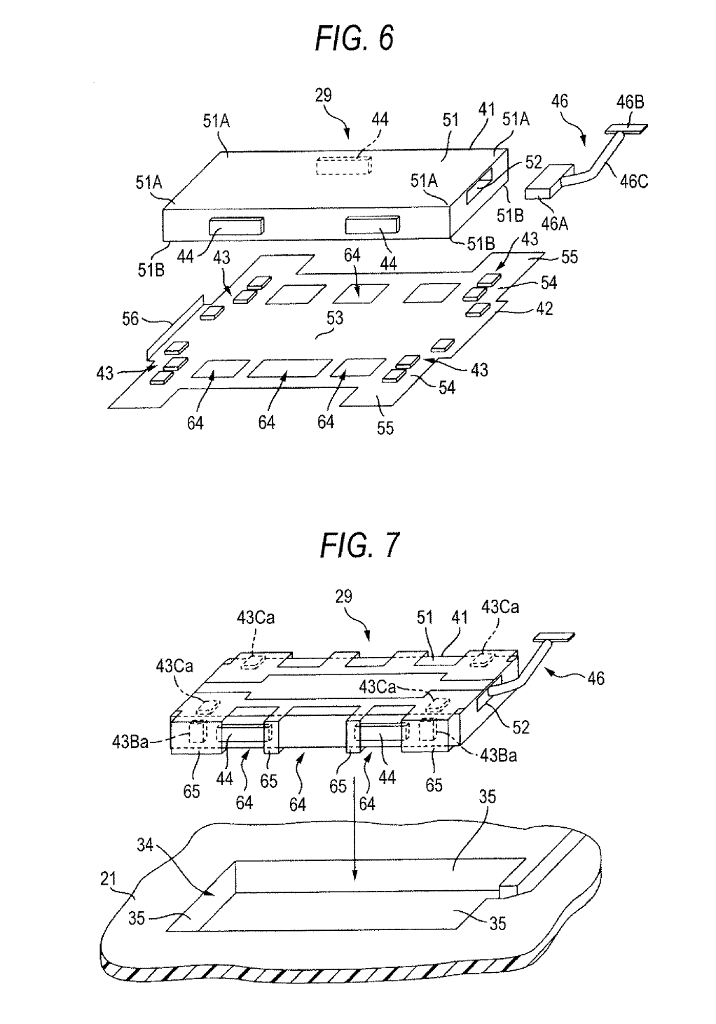

As shown in FIGS. 3 and 6, the disk device 29 includes a main body 41, a resin sheet 42 that is wrapped around the main body 41 to surround the main body 41, plural cushion members 43 that are disposed between the main body 41 and the resin sheet 42, gaskets 44 as grounding members for grounding the main body 41 to the ground layers 35, double-sided adhesive tapes 45 for bonding the resin sheet 42 to the main body 41, and a cable 46 for connecting the main body 41 to the printed circuit board 33.

The main body 41 includes a casing 51, a magnetic disk (not shown) and a motor (not shown) for rotating the magnetic disk which are housed in the casing 51, a frame ground (not shown) which is housed in the casing 51, and a connector 52 which is formed in one wall of the casing 51. The casing 51 has four first corner portions 51A in the top face and four second corner portions 51B in the bottom face.

As shown in FIG. 6, the cable 46 has a first connector 46A which is to be connected to the connector 52 of the main body 41, a second connector 46B which is to be connected to the printed circuit board 33, and a wiring portion 46C which connects the first connector 46A and the second connector 46B. In this embodiment, since the printed circuit board 33 and the disk device 29 are connected to each other by the cable 46, vibration of the case 21 is hardly transmitted to the disk device 29.

As shown in FIG. 3, the gaskets 44 are made of a metal material and project from the side faces of the main body 41. As shown in FIG. 7, the gaskets 44 project approximately perpendicularly to the direction in which the disk device 29 is inserted into the mounting slot 34. The gaskets 44 are brought into contact with the ground layers 35, whereby the main body 41 of the disk device 29 can be grounded to the ground layers 35. The ground layers 35 and the frame ground are provided for the purposes of reducing the amount of electromagnetic waves emitted outward from the portable computer 11 and preventing external static electricity from adversely affecting the printed circuit board 33.

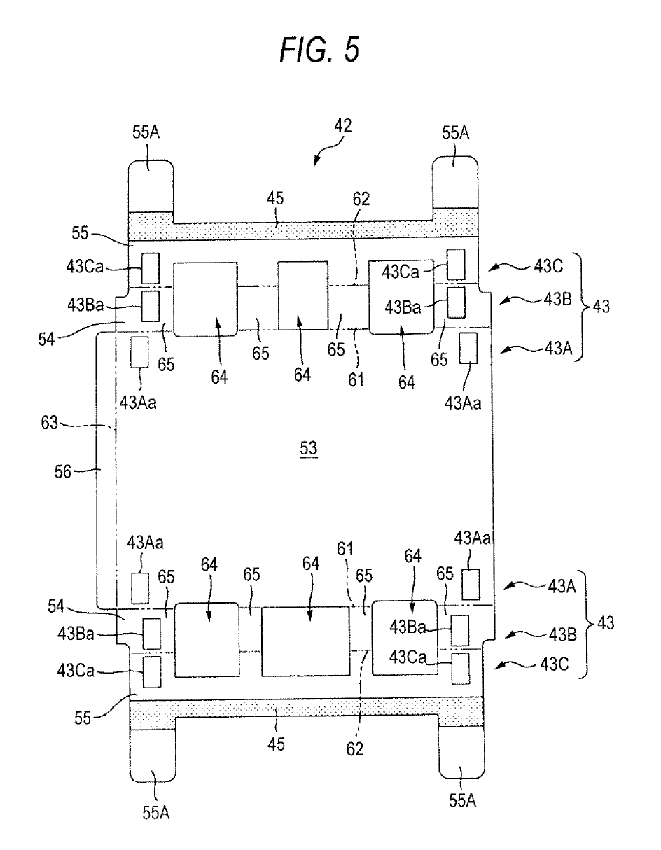

The resin sheet 42 shown in FIG. 5 is a transparent film made of a polyethylene terephthalate resin, for example. As shown in FIG. 3, the resin sheet 42 surrounds the main body 41 excluding the connector 52. The face of the resin sheet 42 is made smooth, which allows the disk device 29 to be inserted into the mounting slot 34 of the case 21 with high slidability.

The resin sheet 42 has a bottom portion 53 which is to be laid on the bottom face of the main body 41, a pair of side portions 54 which are to be laid on the side faces of the main body 41, a pair of top portions 55 which are to be laid on the top face of the main body 41, and a positioning portion 56 for positioning the resin sheet 42 with respect to the main body 41. First bending lines 61 are formed between the bottom portion 53 and the side portions 54. Second bending lines 62 are formed between the side portions 54 and the top portions 55. A third bending line 63 is formed between the bottom portion 53 and the positioning portion 56.

Six openings 64 in total are formed in the side portions 54 and the top portion 55. The openings 64 are to expose the gaskets 44 which project from the main body 41. Each combination of a side portion 54 and a top portion 55 includes band-like portions 65 which, as shown in FIG. 7, can cover both end portions of each gasket 44. Each top portion 55 has grip portions 55A. The grip portions 55A are used for gripping the resin sheet 42 when it is bonded to the main body 41.

As shown in FIGS. 3-5, each cushion member 43 is a small, sheet-like member and is bonded to the resin sheet 42 in advance. The cushion members 43 are made of a rubber, for example. However, the material of the cushion members 43 is not limited to a rubber and may be any material such as a polyurethane sheet as long as it is elastic.

The cushion members 43 are grouped into a first group 43A of cushion members that are bonded to the bottom portion 53 of the resin sheet 42, a second group 43B of cushion members that are bonded to the side portions 54, and a third group 43C of cushion members that are bonded to the top portions 55. The first group 43A includes four cushion members 43Aa in total which are bonded to four respective corner portions of the bottom portion 53. The second group 43B includes four cushion members 43Ba in total. The two of the four cushion members 43Ba are bonded to both end portions of one side portion 54 and the other two cushion members 43Ba are bonded to both end portions of the other side portion 54.

The third group 43C includes four cushion members 43Ca. Two of the four cushion members 43Ca are bonded to one top portion 55 at both ends on a line extending along the second bending line 62, and the other two cushion members 43Ca are bonded to the other top portion 55 at both ends on a line extending along the second bending line 62. As shown in FIGS. 3 and 7, in a state that the resin sheet 42 is bonded to the main body 41, the cushion members 43Ba of the second group 43B and the cushion members 43Ca of the third group 43C are disposed at positions corresponding to the first corner portions 51A.

As shown in FIGS. 3 and 4, the cushion members 43Aa of the first group 43A and the cushion members 43Ba of the second group 43B are disposed at positions corresponding to the second corner portions 51B.

As shown in FIG. 5, the above-mentioned double-sided adhesive tapes 45 are bonded to band-shaped areas of the respective top portions 55 of the resin sheet 42. The resin sheet 42 can be bonded to the main body 41 by means of the double-sided adhesive tapes 45.

Next, a process for attaching the disk device 29 according to the embodiment to the case 21 will be described with reference to FIGS. 6 and 7. As shown in FIG. 6, first, the resin sheet 42 is positioned with respect to the main body 41 of the disk device 29 and bonded to the latter. The resin sheet 42 is positioned by hooking its positioning portion 56 on the side face of the main body 41. Then, the resin sheet 42 is bent along the first bending lines 61 and the second bending lines 62 and the main body 41 is thereby covered with the resin sheet 42. And the resin sheet 42 is bonded to the main body 41 by means of the double-sided adhesive tapes 45 which are provided on the top portions 55.

Then, the first connector 46A of the cable 46 is inserted into the connector 52 of the main body 41, whereby the disk device 29 is completed. The resin sheet 42 does not obstruct this operation because the resin sheet 42 surrounds the main body 41 excluding the connector 52. As shown in FIG. 7, the completed disk device 29 is inserted into the mounting slot 34 of the case 21. The disk device 29 is inserted into the mounting slot 34 while the gaskets 44 slide on the ground layers 35. Although certain frictional forces act on the gaskets 44, the gaskets 44 are prevented from coming off the main body 41 because both end portions of each gasket 44 are covered with and protected by the band-like portions 65 of the resin sheet 42. The band-like portions 65 reduce the frictional forces acting on the gaskets 44.

The portable computer 11 according to the embodiment is configured as described in the above. In the embodiment, the portable computer 11 is equipped with the case 21 having the mounting slot 34 and the disk device 29 which is mounted in the mounting slot 34. The disk device 29 is equipped with the main body 41, the resin sheet 42 that is wrapped around the main body 41, and the plural cushion members 43 that are disposed between the main body 41 and the resin sheet 42. The cushion members 43 are arranged on the resin sheet 42 at positions where correspond to corners (corner portions 51A and 51B) of the main body 41 in a state where the resin sheet 42 is wrapped around the main body 41.

In the above configuration, the cushion members 43 are disposed at the positions corresponding to the corner portions 51A and 51B of the main body 41, which is in contrast to a structure that a cushion member is formed on the entire face of the resin sheet 42. Therefore, the main body 41 is point-supported by the cushion members 43 which are located near the corner portions 51A and 51B and a central portion of the main body 41 is not in contact with the case 21. As a result, for example, the amounts of vibrations that are transmitted from vibration sources such as the subwoofer 30 to the disk device 29 can be minimized. Since vibrations that are transmitted to the disk device 29 are reduced in this manner, the probability of occurrence of reading errors due to vibration can be lowered.

Since the plural cushion member 43 are provided on the resin sheet 42, the workability of assembling can be made higher than in a case that the cushion members 43 are bonded to the main body 41 individually. Since the cushion members 43 are covered with the resin sheet 42, they can be prevented from coming off being caught on the mounting slot 34 when the disk device 29 is inserted into the mounting slot 34. Furthermore, since the slidability of the disk device 29 with respect to the mounting slot 34 is increased, the disk device 29 can be inserted into the mounting slot 34 smoothly. In the above configuration, the total volume of the cushion members 43 can be reduced, as a result of which the disk device 29 can be reduced in weight and occupation space as well as in manufacturing cost.

The cushion members 43 are formed by small pieces of sheet-like members. This minimizes the total contact area between the main body 41 and the resin sheet 42. This makes it possible to minimize the amounts of vibrations that are transmitted from the case 21 and the resin sheet 42 to the main body 41 of the disk device 29. The cushion members 43 can be formed by cutting out from a sheet-like material, which contributes to reduction of the manufacturing cost of the cushion members 43.

The resin sheet 42 has the positioning portion 56 which is used for positioning the resin sheet 42 with respect to the main body 41. This structure allows the resin sheet 42 to be positioned easily with respect to the main body 41 and can thereby simplify and increase the speed of the assembling process of the disk device 29.

The portable computer 11 is equipped with the printed circuit board 33 which is housed in the case 21. In the disk device 29, the main body 41 has the connector 52 for electrically connecting the main body 41 to the printed circuit board 33 and the resin sheet 42 surrounds the main body excluding the connector 52. This structure prevents reduction in workability when the cable 46 or the like is attached to the connector 52 of the main body 41.

The mounting slot 34 is a recess that is recessed from the surrounding portion of the case 21. This simplifies the structure of the mounting slot 34.

The case 21 is provided with the conductive ground layers 35 which cover the inner circumferential faces of the mounting slot 34. The disk device 29 is equipped with the grounding members which project from the main body 41 approximately perpendicularly to the direction in which the disk device 29 is inserted into the mounting slot 34, and the grounding members are brought into contact with the ground layers 35 and thereby ground the mainbody 41 to the ground layers 35. The disk device 29 is inserted into the mounting slot 34 while the grounding members slide on the ground layers 35. The resin sheet 42 covers parts of each grounding member.

Since parts of each grounding member (i.e., gasket 44) are protected by the resin sheet 42, this structure reduces frictional forces that act on the gaskets 44 when the disk device 29 is inserted into the mounting slot 34 of the case 21 and thereby prevents the gaskets 44 from coming off the main body 41.

As described with reference to the embodiment, there is provided a an electronic apparatus having a disk device capable of minimizing the influence of vibration and increasing the workability when the disk device is attached to the electronic apparatus.

The electronic apparatus according to the invention is not limited to a portable computer and can be applied to other electronic apparatus such as a PDA (personal digital assistant).

The present invention is not limited to the embodiment described above, but the invention may be embodied in practice by modifying constituent components without departing the scope of the claimed invention. Various kinds of inventions may be realized by proper combination of the plurality of constituent components disclosed in the embodiment described above. For example, some constituent components may be eliminated from all the components shown in the above embodiments. Moreover, constituent components in different embodiments may be appropriately combined.

What is claimed is:

1. An electronic apparatus comprising:
a case that is provided with a mounting slot; and
a disk device that is mounted in the mounting slot, the disk device including:
a main body that is formed in a box shape;
a resin sheet that is wrapped around the main body; and
a plurality of cushion members that are disposed between the main body,
wherein the cushion members are arranged on the resin sheet at positions where correspond to corners of the main body in a state where the resin sheet is wrapped around the main body.

2. The apparatus according to claim 1, wherein the cushion members are formed by small pieces of sheet-like members.

3. The apparatus according to claim 1, wherein the resin sheet has a positioning portion for positioning the resin sheet with respect to the main body.

4. The apparatus according to claim 1 further comprising a printed circuit board that is housed in the case,
wherein the main body has a connector for electrically connecting the main body to the printed circuit board, and
wherein the resin sheet is wrapped around the main body to expose the connector.

5. The apparatus according to claim 1, wherein the mounting slot is formed by a recess that is recessed from a surrounding portion of the case.

6. The apparatus according to claim 1, wherein the mounting slot is coated with a conductive ground layer,
wherein the disk device is provided with a grounding member that projects from the main body in a direction perpendicular to a direction in which the disk device is mounted into the mounting slot, the grounding member being configured to be in contact with the ground layer thereby grounding the main body to the ground layer,
wherein the disk device is mounted into the mounting slot while the grounding member slides on the ground layer, and
wherein the resin sheet covers a part of the grounding member.

7. A disk device that is configured to be mounted in a mounting slot provided in a case of an electronic apparatus, the disk device comprising:
a main body that is formed in a box shape;
a resin sheet that is wrapped around the main body; and
a plurality of cushion members that are disposed between the main body,
wherein the cushion members are arranged on the resin sheet at positions where correspond to corners of the main body in a state where the resin sheet is wrapped around the main body.

8. The device according to claim 7, wherein the cushion members are formed by small pieces of sheet-like members.

9. The device according to claim 7, wherein the resin sheet has a positioning portion for positioning the resin sheet with respect to the main body.

10. The device according to claim 7, wherein the main body has a connector for electrically connecting the main body to a printed circuit board of the electronic apparatus, and
wherein the resin sheet is wrapped around the main body is to expose the connector.

11. The device according to claim 7 further comprising a grounding member that projects from the main body in a direction perpendicular to a direction in which the disk device is mounted into the mounting slot, the grounding member being configured to be in contact with a ground layer coated on an inner face of the mounting slot thereby grounding the main body to the ground layer,
wherein the disk device is mounted into the mounting slot while the grounding member slides on the ground layer, and
wherein the resin sheet covers a part of the grounding member.
